(19) United States
(12) Patent Application Publication
(10) Pub. No.: US 2026/0181704 A1
(43) Pub. Date: Jun. 25, 2026

(54) METHODS AND APPARATUSES FOR PRACH TRANSMISSION LATENCY REDUCTION

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 19/132,505

(22) PCT Filed: Jan. 19, 2023
(86) PCT No.: PCT/CN2023/073128

§ 371 Date: May 23, 2025

(51) Int. Cl. H04W 74/0833; H04L 1/08

(52) U.S. Cl. CPC H04W 74/0833; H04L 1/08

(57) ABSTRACT

The present application relates to methods and apparatuses for physical random access channel (PRACH) transmission latency reduction. One embodiment of the present disclosure provides a user equipment (UE), comprising: a transceiver; and a processor coupled with the transceiver and configured to: receive a first configuration associated with PRACH repetition; and determine random access channel occasions (ROs) for PRACH repetition, based on a first total number of PRACH repetition configured by the first configuration.

### TECHNICAL FIELD

The present disclosure relates to wireless communication, and particularly relates to methods and apparatuses for physical random access channel (PRACH) transmission latency reduction.

### BACKGROUND OF THE INVENTION

In a time division duplex (TDD) system (which may be in frequency range 1 (FR1) or frequency range 2(FR2)), the UL slots in one downlink (DL) or uplink (UL) configuration pattern may be limited. For example, for a configuration pattern such as DDDSU, where D stands for “DL”, S stands for “special”, and “U” stands for “UL”. It can be seen only one UL slot is configured in this pattern.

In this scenario, the PRACH repetition transmission may be performed in the UL slots in multiple DL/UL configuration patterns, which may cause high PRACH transmission latency.

Therefore, it is desirable to provide solutions for PRACH transmission latency reduction.

### SUMMARY

One embodiment of the present disclosure provides a user equipment (UE), comprising: a transceiver; and a processor coupled with the transceiver and configured to: receive a first configuration associated with physical random access channel (PRACH) repetition; and determine random access channel occasions (ROs) for PRACH repetition, based on a first total number of PRACH repetition configured by the first configuration.

In some embodiments, the ROs for PRACH repetition are included in at least one RO bundle, and wherein an RO bundle includes a set of ROs associated with a synchronization signal and physical broadcast channel (PBCH) block (SSB), and the processor is further configured to: determine a first RO of an RO bundle as the starting RO for PRACH repetition.

In some embodiments, a first RO bundle associated with the SSB starts from a first RO in a first frame that is associated with the SSB.

In some embodiments, the ROs for PRACH repetition are included in one RO bundle, and wherein an RO bundle includes the first total number of ROS associated with an SSB, and the processor is further configured to receive a second configuration which indicates one of the following: a set of indices of candidate starting ROs of the RO bundle; an offset associated with a first RO of the RO bundle; or a total number of candidate starting ROs in the RO bundle.

In some embodiments, the processor is further configured to: determine a starting RO of the ROs for PRACH repetition, wherein the starting RO in the RO bundle is one of the following: a first RO of the RO bundle; a candidate starting RO identified by an index of the set of indices; or a candidate starting RO with the offset associated with the first RO of the RO bundle.

In some embodiments, the processor is further configured to receive a third configuration, which indicates one of the following: a periodicity of candidate starting ROs associated with an SSB; or the periodicity of candidate starting ROs associated with the SSB and an offset associated with a first RO.

In some embodiments, the processor is further configured to: determine a set of candidate starting ROs based on the periodicity or based on the periodicity and the offset, wherein a first candidate starting RO is a first RO associated with the SSB in a first frame.

In some embodiments, the processor is further configured to determine a period based on the first total number of PRACH repetition, and a second total number of ROs associated with an SSB from a set of SSBs in the period, and wherein the second total number of ROs is equal to or larger than the first total number.

In some embodiments, the second total number is an integral multiple of the first total number.

In some embodiments, the period is an SSB to RO association period, or an SSB to RO association pattern period, wherein the SSB to RO association pattern period includes at least one SSB to RO association period.

In some embodiments, the period includes a number of RO bundles, each RO bundle includes a set of ROs associated with the SSB, and the number of ROs in the set is equal to or less than the first total number.

In some embodiments, a candidate starting RO for PRACH repetition is a first RO of a RO bundle.

In some embodiments, each RO associated with the SSB in the period is indexed, and a first RO associated with the SSB in the period is candidate starting RO, and an RO with an index value that is divisible by the first total number is a candidate starting RO.

In some embodiments, a candidate starting RO of the ROs for PRACH repetition is associated with a preamble set.

In some embodiments, a total number of preambles in the preamble set is determined by the first total number and a density of candidate starting ROs in a period determined based on the first total number of PRACH repetition.

In some embodiments, the processor is further configured to: determine the ROs for PRACH repetition except a starting RO as the ROs associated with a same SSB and following the starting ROs in the time domain, where in the starting RO is associated with the same SSB.

Another embodiment of the present disclosure provides a base station (BS), comprising: a transceiver; and a processor coupled with the transceiver and configured to: transmit a first configuration associated with PRACH repetition; and determine ROs for receiving PRACH repetition based on a first total number of PRACH repetition.

In some embodiments, the ROs for PRACH repetition are included in at least one RO bundle, and wherein an RO bundle includes a set of ROs associated with a SSB, and the processor is further configured to: determine a first RO of the RO bundle as the starting RO for PRACH repetition.

In some embodiments, a first RO bundle associated with the SSB starts from a first RO in a first frame that is associated with the SSB.

In some embodiments, the ROs for PRACH repetition are included in one RO bundle, and wherein an RO bundle includes the first total number of ROS associated with a SSB, and a second configuration indicates one of the following: a set of indices of candidate starting ROs of the RO bundle; an offset associated with a first RO of the RO bundle; or a total number of candidate starting ROs in the RO bundle.

In some embodiments, the processor is further configured to: determine a starting RO of the ROs for PRACH repetition, wherein the starting RO in the RO bundle is one of the following: a first RO of the RO bundle; a candidate starting RO identified by an index of the set of indices; or a candidate starting RO with the offset associated with the first RO of the RO bundle.

In some embodiments, a third configuration indicates one of the following: a periodicity of candidate starting ROs associated with an SSB; or the periodicity of candidate starting ROs associated with the SSB and an offset associated with a first RO.

In some embodiments, the processor is further configured to: determine a set of candidate starting ROs based on the periodicity or based on the periodicity and the offset, wherein a first candidate starting RO is a first RO associated with the SSB in a first frame.

In some embodiments, a period is determined based on the first total number of PRACH repetition, and wherein a second total number of ROs associated with an SSB from a set of SSBs in the period is equal to or larger than the first total number.

In some embodiments, the second total number is an integral multiple of the first total number.

In some embodiments, the period is an SSB to RO association period, or an SSB to RO association pattern period, wherein the SSB to RO association pattern period includes at least one SSB to RO association period.

In some embodiments, the period includes a number of RO bundles, each RO bundle includes a set of ROs associated with the SSB, and the number of ROs in the set is equal to or less than the first total number.

In some embodiments, a candidate starting RO for PRACH repetition is a first RO of a RO bundle.

In some embodiments, each RO associated with the SSB in the period is indexed, and a first RO associated with the SSB in the period is candidate starting RO, and an RO with an index value that is divisible by the first total number is a candidate starting RO.

In some embodiments, a candidate starting RO of the ROs for PRACH repetition is associated with a preamble set.

In some embodiments, a total number of preambles in the preamble set is determined by the first total number and a density of candidate starting ROs in a period determined based on the first total number of PRACH repetition.

In some embodiments, the processor is further configured to: determine the ROS for PRACH repetition except a starting RO as the ROs associated with a same SSB and following the starting ROs in the time domain, where in the starting RO is associated with the same SSB.

Yet another embodiment of the present disclosure provides a method performed by a UE, comprising: receiving a first configuration associated with PRACH repetition; and determine ROs for PRACH repetition based on a first total number of PRACH repetition configured by the first configuration.

Still another embodiment of the present disclosure provides a method performed by a base station (BS), comprising: transmitting a first configuration associated with PRACH repetition; and determining ROs for receiving PRACH repetition based on a first total number of PRACH repetition.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a random-access procedure according to some embodiments of the present disclosure.

FIG. 3 illustrates a structure of the overall resources for PRACH transmission according to some embodiments of the present disclosure.

FIGS. 4A-4C illustrate some types of associations between ROs and SSBs according to some embodiments of the present disclosure.

FIG. 5 illustrates SSB to RO association periods according to some embodiments of the present disclosure.

FIG. 6 illustrates a PRACH repetition transmission in an RO bundle according to some embodiments of the present disclosure.

FIG. 7 illustrates a PRACH repetition transmission in an RO bundle according to some embodiments of the present disclosure.

FIG. 8 illustrates a PRACH repetition transmission in an RO bundle according to some embodiments of the present disclosure.

FIG. 9 illustrates a PRACH repetition transmission according to some embodiments of the present disclosure.

FIG. 10 illustrates a proposed SSB to RO association period according to some embodiments of the present disclosure.

FIG. 11 illustrates a proposed SSB to RO association period according to some embodiments of the present disclosure.

FIG. 12 illustrates a method of preamble partitioning for PRACH repetition according to some embodiments of the present disclosure.

FIG. 13 illustrates a method performed by a UE for wireless communication according to some embodiments of the present disclosure.

FIG. 14 illustrates a method performed by a BS for wireless communication according to some embodiments of the present disclosure.

FIG. 15 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a schematic diagram of a wireless communication system according to some embodiments of the present disclosure.

As shown in FIG. 1, the wireless communication system 100 may include at least one UE (e.g., UE 101-A and UE 101-B, collectively referred to as UEs 101) and at least one BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 may include wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a general Node B (gNB), a Home Node-B, a relay node, or a device, or described using other terminology used in the art. The BS 102 is generally a part of a radio access network that may include one or more controllers communicably coupled to one or more corresponding BS 102. The BS 102 may communicate with the UE(s) 101 via Uu interface. For example, the BS 102 may transmit downlink DL communication signals to the UE(s) 101, and may receive uplink (UL) communication signals from the UE(s) 101.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, the BS 102 may transmit data using an orthogonal frequency division multiplexing (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

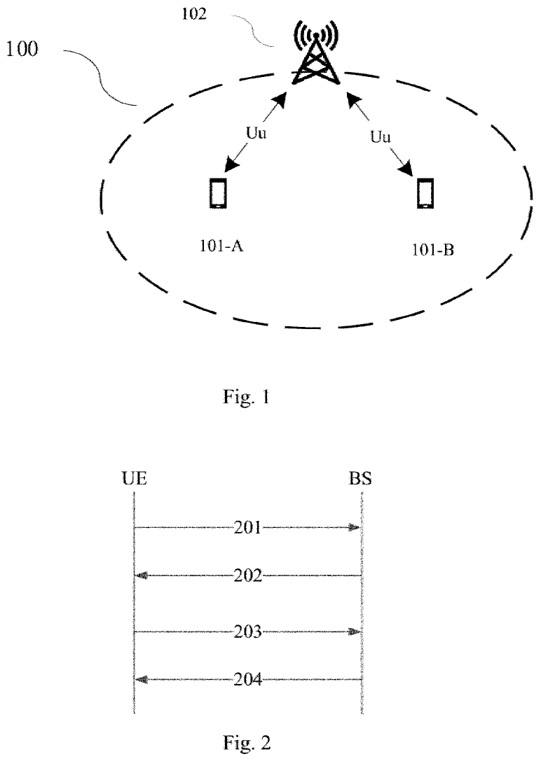

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums via a Uu interface, whereas in some other embodiments, the BS 102 and UE(s) 101 may communicate over unlicensed spectrums. The present disclosure is not intended to be limited to the implementation of any particular wireless FIG. 2 illustrates a random-access procedure according to some embodiments of the present disclosure.

A random-access procedure may be utilized for various purposes. It may be utilized by a UE in initial access to find a cell to camp on; or utilized by UE in a radio resource control (RRC) idle state of an RRC inactive state to switch to an RRC connected to start data transmission or reception; or utilized by an RRC connected UE to re-establish the lost UL synchronization, etc.

In operation 201, the UE may transmit a message, i.e. Msg1, which may include a preamble. In operation 202, the UE may receive an Msg2 including a random-access response (RAR), which indicates the reception of the preamble and provides scheduling information for the transmission of an Msg3. In operation 203, the UE may transmit the Msg3 according to the scheduling information, and in operation 204, the UE may receive an Msg4 from the BS. The Msg3 and the Msg4 are used to solve potential collisions due to simultaneous transmissions of the same preamble from different UEs.

The PRACH preamble (i.e., Msg1) transmission may be performed in PRACH occasions (ROs). Each RO may occupy multiple consecutive resource blocks in the frequency domain. The BS may configure one or more FDMed ROs for a time instance. In the time domain, the ROs may be configured in every PRACH configuration period, which may contain one or more radio frames. Within a PRACH configuration period, a set of subframes may be indicated to contain a set of PRACH slots, and within each PRACH slot, there may be a set of ROs available for PRACH preamble transmission.

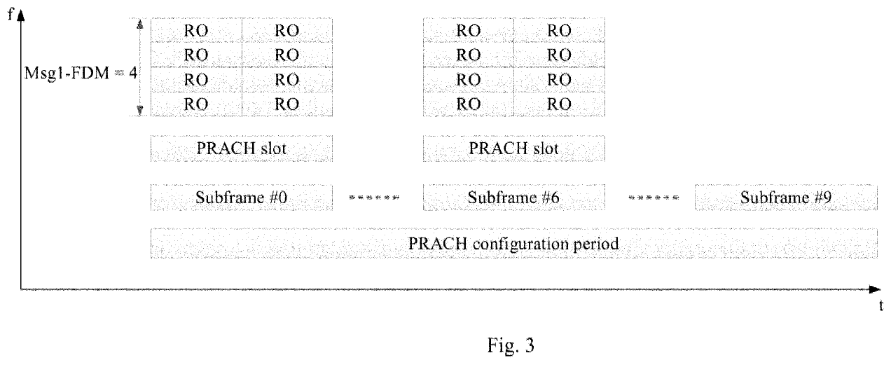

FIG. 3 illustrates a structure of the overall resources for PRACH transmission according to some embodiments of the present disclosure.

FIG. 3 depicts a PRACH configuration period, which may include 1 radio frame in the time domain. The frame may include 10 subframes, subframe #0,subframe #1, . . . , subframe #9. Subframe #0 and subframe #6 in the PRACH configuration period may be indicated to contain PRACH slots. The PRACH slot in subframe #0 or subframe #6 may include 2 ROs in the time domain and 4 ROs (i.e. the parameter, e.g. msg1-FDM may indicate that there are 4 RO occasions in the frequency domain, i.e. Msg1-FDM=4) in the frequency domain.

The ROs may be associated with synchronization signal and PBCH blocks (SSBs). One SSB may be transmitted with a specific beam. The SSBs may consist of primary synchronization signal (PSS) or secondary synchronization signal (SSS) and PBCH for the UE to sync to the DL, obtain the cell ID, and acquire the major system information. The UE may measure the channel status of each SSB, select the one with good (best) channel quality, and transmit preamble in an RO that is associated with the SSB with good (best) channel quality. With this, the preamble may be received in the BS by a proper receive beam, which may be correspondent with selected beam for SSB transmission.

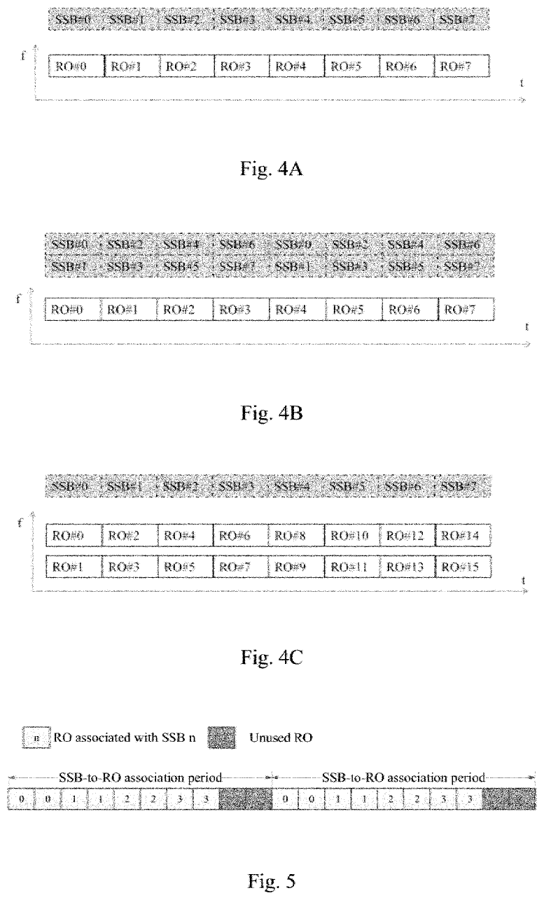

FIGS. 4A-4C illustrate some types of associations between ROs and SSBs according to some embodiments of the present disclosure.

There may be different types of associations of SSBs (beams) and ROs. The association of SSBs and ROs may include: 1-to−1, 1-to−N, or N-to−1 depending on a network configuration. The association may be determined by a parameter, e.g. SSB-PerRACH-Occasion.

FIG. 4A illustrates a 1-to−1 association between SSBs and ROs, the parameter SSB-PerRACH-Occasion may be configured with a value 1, i.e. SSB-PerRACH-Occasion=1. That is, one SSB may be associated with one RO. For example, SSB #0 may be associated with RO #0, SSB #1 may be associated with RO #1, etc.

FIG. 4B illustrates an N-to−1 association between SSBs and ROs, the parameter SSB-PerRACH-Occasion may be configured with a value 2, i.e. SSB-PerRACH-Occasion=2. That is, two SSBs may be associated with one RO. For example, SSB #0 and SSB #1 may be associated with RO #0, SSB #2 and SSB #3 may be associated with RO #1, etc.

FIG. 4C illustrates a 1-to−N association between SSBs and ROs, the parameter SSB-PerRACH-Occasion may be configured with a value ½, i.e. SSB-PerRACH-Occasion=½. That is, one SSB may be associated with two ROs. For example, SSB #0 may be associated with RO #0 and RO #1, and the two ROs may be FDMed in the frequency domain, SSB #1 may be associated with RO #2 and RO #3, etc.

The association of SSBs and ROs may be performed in an SSB to RO association period. The SSB to RO association period may be a number of times of the PRACH configuration period (e.g. the PRACH configuration period as described in FIG. 3), and may contain one or more SSB-to-RO mapping cycles. The duration of an SSB to RO association period may be the minimum period such that within the SSB to RO association period, each SSB may be associated with at least one RO. In some embodiments, there may be some ROs within the association period and are not associated with any SSBs, and these ROs are not used for PRACH transmission, and they may be referred to as unused ROs.

FIG. 5 illustrates SSB to RO association periods according to some embodiments of the present disclosure.

In FIG. 5, there are two SSB to RO association periods. Each SSB to RO association period may include two SSB mapping cycles, and there are two unused ROs within each SSB to RO association period. More specifically, two ROs are associated with SSB #0, two ROs are associated with SSB #1, two ROs are associated with SSB #2, and two ROs are associated with SSB #3, and two unused ROs.

It should be noted that although the ROs may be continuous in FIG. 5 and other drawings (such as, FIGS. 4A, 4B and 4C), in some other scenarios such as in TDD systems where ROs are configured in discontinuous UL slots, the ROs may not be continuous. For these scenarios including continuous ROs or discontinuous ROs, the solutions of the present disclosure still apply.

PRACH preamble may be transmitted without repetition. In some cases, for example, short PRACH formats (e.g., PRACH format B) may be used, and the formats may be the bottleneck channel. Therefore, PRACH coverage should be recovered for at least some of the PRACH formats. PRACH repetition transmission may be used to recover the PRACH coverage.

However, the PRACH repetition transmission may have high transmission latency since it may be performed in UL slots in multiple DL/UL configuration patterns in TDD system.

Furthermore for both TDD and frequency division duplex (FDD) systems, to use joint detection for PRACH repetition, the time domain starting position (i.e., starting RO position) for PRACH repetition should be known by the BS and the UE, otherwise the BS may not know which set of ROs are used for PRACH repetition. As one solution, an RO bundle is introduced and PRACH repetition is transmitted in the ROs in an RO bundle. Correspondingly, the starting RO of an RO bundle is the starting RO for PRACH repetition. Based on this structure, once the UE initiates an PRACH procedure, it may not start the PRACH transmission until a starting RO of an RO bundle.

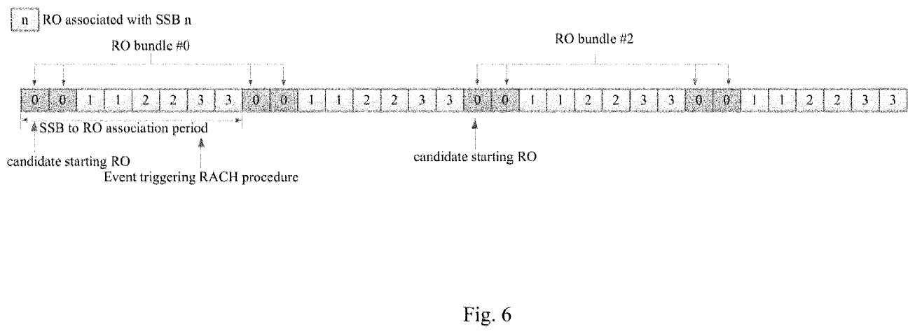

FIG. 6 illustrates a PRACH repetition transmission in an RO bundle according to some embodiments of the present disclosure.

In FIG. 6, there are four SSB to RO association periods. Each SSB to RO association period may include two ROs associated with SSB #0, SSB #1, SSB #2, and SSB #3 respectively. The PRACH repetition number is 4. Correspondingly, 4 ROs are required for the PRACH repetition. An RO bundle which includes 4 ROs may be associated with the same SSB. For example, in FIG. 6, there are two RO bundles each including 4 ROs associated with SSB #0, e.g. RO bundle #0 and RO bundle #1. The UE may select SSB #0 and may transmit PRACH repetition in the ROs that are associated with SSB #0. When an event triggers a PRACH repetition, for example, the event may happen at the time of an RO associated with SSB #3 in the first SSB to RO association period, as shown in FIG. 6, the UE cannot perform the PRACH transmission until a starting position of an RO bundle. That is, the UE may not perform the PRACH repetition transmission in RO bundle #0, and may perform the PRACH repetition transmission in RO bundle #1. As can be seen, this long waiting time may render high PRACH transmission latency.

In order to reduce PRACH transmission latency, the present disclosure proposes denser starting ROs for PRACH repetition. The UE (or the BS) may determine a set of candidate starting ROs for PRACH repetition, wherein the time gap (in terms of number of ROs associated with the same SSB) between two neighboring candidate starting ROs may be the same with or lower than the number of ROs for PRACH repetition. By having such denser candidate starting ROs, the UE may wait less time to start an RACH procedure. Therefore, the PRACH transmission latency can be reduced.

### Solution 1

In solution 1, the UE (or the BS) may determine the candidate starting ROs for PRACH repetition within an RO bundle. The RO bundle may contain a set of ROs associated with the same SSB. The first RO bundle associated with a specific SSB may start from the first RO in frame 0 that is associated with the SSB. Hereinafter in the present disclosure, the number of PRACH repetition may be denoted as “N” for clarity. N ROs are required for the PRACH repetition.

### Solution 1-1

In some embodiments, for an SSB (which may be any SSB that are configured for RO association), the number of ROs associated with the SSB (or any SSB that are configured for RO association) in one RO bundle may range from one to N−1. That is, one RO bundle may include at least one RO, and may have smaller number of ROs than PRACH repetition. In this case, the candidate starting ROs may be the first ROs of each RO bundle. Accordingly, the UE (or the BS) may select a starting RO from the candidate starting ROs, i.e. the first ROs of each RO bundle. In the UE side, the number of ROs in an RO bundle may be determined based on a configuration from the base station, or may be predefined.

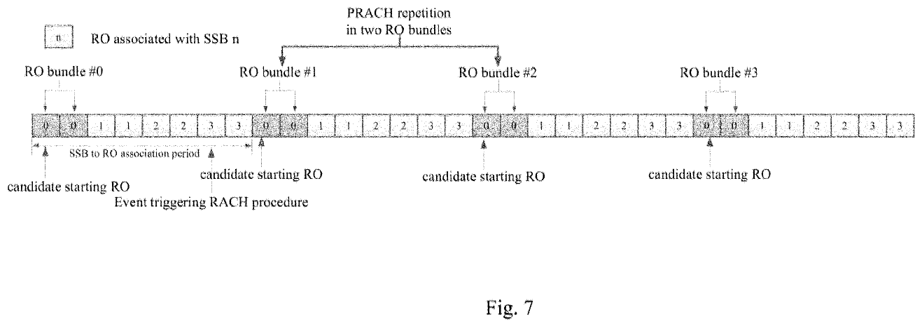

FIG. 7 illustrates a PRACH repetition transmission in an RO bundle according to some embodiments of the present disclosure.

In FIG. 7, there are four SSB to RO association periods. Each SSB to RO association period may include two ROs associated with SSB #0, SSB #1, SSB #2, and SSB #3 respectively. One bundle may include two ROs associated with the same SSB, based on BS configuration. For example, for SSB #0, there are four RO bundles, i.e. RO bundle #0, RO bundle #1, RO bundle #2, and RO bundle #3, each RO bundle includes two ROs associated with SSB #0. Each first RO in the RO bundle is a candidate starting RO for PRACH repetition. That is, the UE may start a PRACH repetition from a candidate starting RO.

The PRACH repetition number is 4. Correspondingly, 4 ROs are required for the PRACH repetition. The UE may select SSB #0 and may transmit PRACH repetition in the ROs that are associated with SSB #0. When an event triggers a PRACH repetition, for example, the event may happen at the time of an RO associated with SSB #3 in the first SSB to RO association period, as shown in FIG. 7, the UE may select the nearest candidate starting RO (relative to the event), i.e. a candidate starting RO that nearest to the event among all candidate starting ROS, which is the first RO of an RO bundle that nearest to the event, to transmit the PRACH repetition. In this case, one PRACH repetition are transmitted in two RO bundles, i.e. RO bundle #1 and RO bundle #2.

### Solution 1-2

In some other embodiments, for an SSB (which may be any SSB), the number of ROs associated with the SSB (or any SSB) in one RO bundle may be N. That is, one RO bundle may have the same number of ROs with PRACH repetition number. In this case, the candidate starting ROs may be determined based on a configuration, which may be received from the BS, and the configuration may indicate at least one of the following:
a) a set of candidate starting RO indices within an RO bundle. This may require the ROs within each RO bundle being indexed;
b) at least one RO offset within an RO bundle. An RO offset may indicate the number ROs relative to the first RO in the RO bundle; or
c) the number of candidate starting ROs in an RO bundle.

The first RO in an RO bundle may be always taken as a candidate starting RO, and other candidate starting ROs may be determined based on the above indications in the configuration.

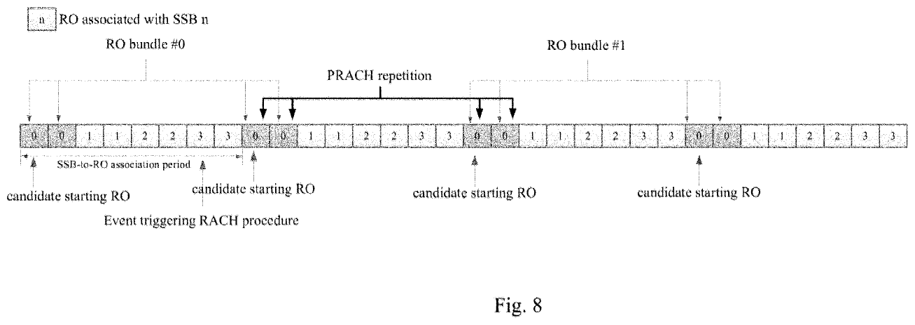

FIG. 8 illustrates a PRACH repetition transmission in an RO bundle according to some embodiments of the present disclosure.

In FIG. 8, there are four SSB to RO association periods. Each SSB to RO association period may include two ROs associated with SSB #0, SSB #1, SSB #2, and SSB #3 respectively. One RO bundle may include four ROs associated with the same SSB, the four ROs in one bundle may be four ROs in two SSB to RO association periods. For example, for SSB #0, there are two RO bundles, i.e. RO bundle #0 and RO bundle #1. Each first RO in the RO bundle may be a candidate starting RO for PRACH repetition.

The configuration may indicate:
a) a set of candidate starting RO indices within an RO bundle. For example, taking RO bundle #0 as an example, the four ROs associated with SSB #0 may be indexed as RO #0, RO #1, RO #2, and RO #3 within RO bundle #0. The set of candidate starting RO indices within an RO bundle may include: {RO #0, RO #2}. Therefore, as shown in FIG. 8, there are two candidate starting ROs in RO bundle #0 and RO bundle #1.
b) at least one RO offset within an RO bundle. For example, an offset value may be 2. In this case, the first RO in the RO bundle, which may be index as RO #0, may be the candidate starting RO, and the third RO, which may be index as candidate starting RO #2, has an offset value 2 relative to candidate starting RO #0, is also an candidate starting RO.
c) the total number of candidate starting ROs in an RO bundle. For example, the number of candidate starting ROs in one RO bundle may be 2. In this case, the first RO in the RO bundle and the third RO in one RO bundle may be considered as two candidate starting ROs.

The PRACH repetition number is 4. Correspondingly, 4 ROs are required for the PRACH repetition. The UE may select SSB #0 and may transmit PRACH repetition in the ROs that are associated with SSB #0. Based on the above configuration, the UE may determine two candidate starting ROs in each RO bundle. When an event triggers a PRACH procedure, the UE may select the nearest candidate starting RO (relative to the event) in an RO bundle to transmit the PRACH repetition. Accordingly, the UE may select the second candidate starting RO in RO bundle #0, and perform the PRACH repetition transmission.

### Solution 2

In this solution, the UE may receive a configuration indicating a configured time periodicity for candidate starting ROs, and the UE may determine candidate starting ROs for PRACH repetition at least based on the configured time periodicity for candidate starting ROs. The periodicity is in terms of a number of ROS associated with the same SSB, for example, the periodicity is in terms of a number of ROs associated with SSB #0, if SSB #0 is selected by the UE.

In order to determine the candidate starting ROs based on the periodicity, the ROs associated with the same SSB may be indexed. The indexing may start from the first RO associated with the SSB in frame 0. Hereinafter in the present disclosure, the periodicity may be denoted as “K” for clarity. It is supposed that the ROs associated with an SSB (for example, SSB #0) for PRACH repetition may be indexed as: RO #0, RO #1, RO #2, RO #1, RO #3 . . . The candidate starting ROS associated with the SSB for PRACH repetition may include: RO #0, RO #(K−1), . . . , RO #(m×K−1), where K is the periodicity of candidate starting ROs, and m is an integer equal to or larger than two.

In some embodiments, the configuration may further indicate an RO offset, which may be denoted as “j” for clarity. In this case, the candidate starting ROS associated an SSB for PRACH repetition will be RO #j, RO #(j+K−1), . . . RO #(j+m×K−1), . . . , where K is the periodicity of candidate starting ROs, m is an integer equal to or larger than two, and j is the RO offset.

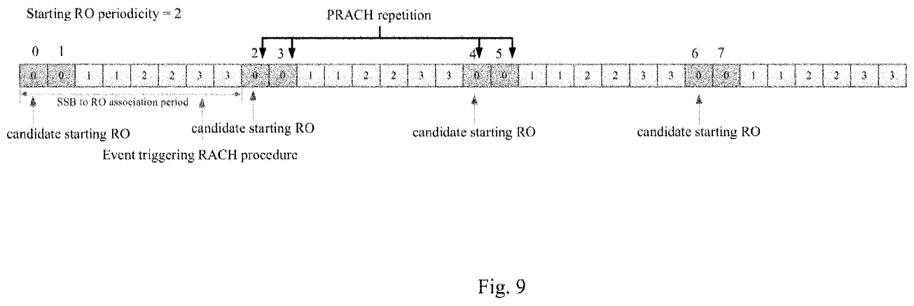

FIG. 9 illustrates a PRACH repetition transmission according to some embodiments of the present disclosure.

In FIG. 9, there are four SSB to RO association periods. Each SSB to RO association period may include two ROs associated with SSB #0, SSB #1, SSB #2, and SSB #3 respectively. Taking SSB #0 as an example, the ROs associated with SSB #0 may be indexed as: RO #0, RO #1, RO #2, . . . , RO #7. The PRACH repetition number may be 4 and the candidate starting RO periodicity may be indicated as 2.

Accordingly, the candidate starting ROs associated with SSB #0 may include: RO #0, RO #2, RO #4, and RO #6. When an event triggers a PRACH repetition, for example, the event may happen at the time of an RO associated with SSB #3 in the first SSB to RO association period, as shown in FIG. 9, the UE may select the nearest candidate starting RO, i.e. RO #2, to transmit the PRACH repetition.

Although there are no such ROs, which are not associated with any SSB (e.g. “Unused RO” as shown in FIG. 5), shown in FIGS. 6-9, a person skilled in the art should understand that these figures are merely schematic and do not represent a limitation. To be more particularly, the SSB to RO association period may include unused ROs or not, which does not impact the implementation of the above solutions.

### Solution 3

In this solution, a period may be defined. The period may be referred to as “a PRACH repetition period”, “a new SSB to RO association period”, “an SSB to RO association period”, “a new SSB to RO association period for PRACH repetition”, or “an SSB to RO association period for PRACH repetition”, or the like. Hereinafter in the present discourse, the expression “a proposed SSB to RO association period” may be used to describe the solutions. It should be noted that the proposed SSB to RO association period is still a type of SSB to RO association period.

In some embodiments, the proposed SSB to RO association period may include one or more SSB to RO association periods. The candidate starting ROs may be determined within each proposed SSB to RO association period.

In some embodiments, the proposed SSB to RO association period may be determined based on PRACH repetition number. An association period for PRACH repetition, starting from frame 0, for mapping SSBs to ROs may include at least one PRACH configuration period (for example, the PRACH configuration period as shown in FIG. 3), and each SSB may be associated with at least N ROs within the proposed SSB to RO association period, where N is the number of PRACH repetition.

In some embodiments, the proposed SSB to RO association period may be determined such that each SSB is associated with L×N ROs, where N is the number of PRACH repetition and L is an integer with a value being predefined or configured by the BS.

In some embodiments, after associating the SSBs with the ROs, there are some ROs left in the proposed SSB to RO association period that are not associated with any SSB, these ROs may not be used for PRACH transmission, and they may be referred as unused ROs.

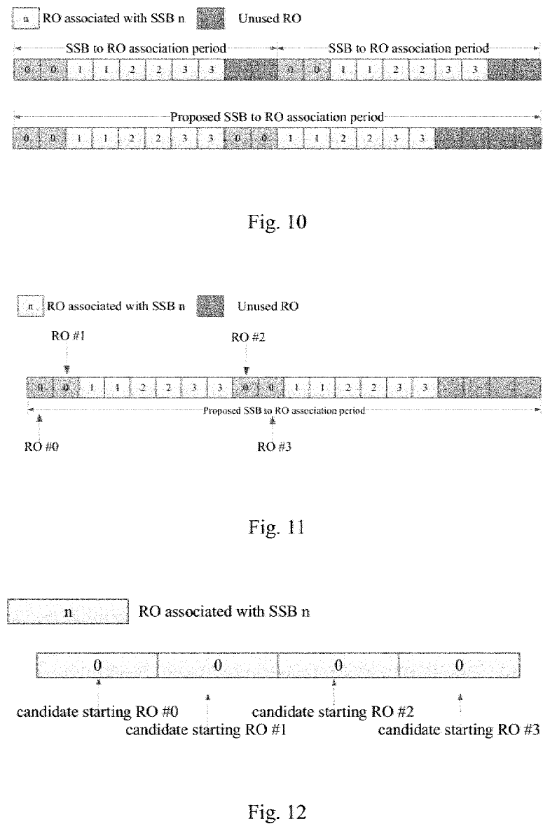

FIG. 10 illustrates a proposed SSB to RO association period according to some embodiments of the present disclosure.

In FIG. 10, the number of PRACH repetition may be 4. In the SSB to RO association period, one SSB is associated with two ROs in one SSB to RO association period, and there are two ROs not associated with any SSB, therefore, there are two unused ROs in each SSB to RO association period. It is supposed that the SSB #0 is selected, and for the PRACH repetition transmission, two ROs associated with SSB #0 in one SSB to RO association period and another two ROs associated with SSB #0 in the next SSB to RO association period are involved. The existence of the two unused ROs renders the PRACH repetition transmission latency larger.

In the proposed SSB to RO association period, one SSB is associated with four ROs (which is the same with the number of PRACH repetition). It can be observed that different from PRACH repetition based on SSB to RO association, there are no unused ROs during PRACH repetition for the proposed SSB to RO association period. For example, there is no unused ROs between the four ROs associated with SSB #0. Therefore, PRACH transmission latency is reduced compared with the PRACH repetition transmission latency with the SSB to RO association period.

With the proposed SSB to RO association period, a PRACH repetition is always transmitted within one proposed SSB to RO association period. In some other embodiments, an SSB to RO association pattern period is proposed, that may include at least one proposed SSB to RO association period.

For each proposed SSB to RO association period, one or more candidate starting ROs may be determined. The number of the candidate starting ROs may at least depend on the total number of ROs associated with an SSB in the association period and/or a configuration for candidate starting RO determination. The details are as follows:

It is supposed that one proposed SSB to RO association period may include L×N ROs associated with one SSB, wherein N is the number of PRACH repetition, and L may be an integer equal to or larger than one. Accordingly, there are L candidate starting ROs for PRACH repetition within the proposed SSB to RO association period. The L candidate starting ROs may be determined by the following options:

### Option 1:

One or more RO bundles may be defined within each proposed SSB to RO association period, wherein each RO bundle may contain N ROs associated with the same SSB. For an SSB, the first RO of the first RO bundle is the first RO in the proposed association period that is associated with the SSB. Since one proposed SSB to RO association period may include L×N ROs associated with an SSB, correspondingly there may be L RO bundles determined within each proposed SSB to RO association period. The first RO of an RO bundle may be determined as the candidate starting RO for PRACH repetition.

### Option 2:

ROs associated with the same SSB within the proposed SSB to RO association period are indexed. The index may start from 0, then the ROs associated with the same SSB may include: RO #0, RO #1, RO #2, . . . RO #(L×N−1). The index of the candidate starting ROs may be calculated as follows: mod(RO_index, N)=0, where N is PRACH repetition number, and RO_index is RO index within an SSB to RO association period. Alternatively, the index of the candidate starting ROs may be a value that is divisible by N. That is, the index of the candidate starting ROs may include: RO #0, RO #N, RO #(2×N), . . . RO #((L−1)×N).

Alternatively, the candidate starting ROs may include: RO #0, RO #1, RO #2, . . . RO #((L−1)×N). The PRACH repetition transmission may be performed in RO #0 to RO #(N−1) in the case the determined starting RO is RO #0; the PRACH repetition transmission may be performed in RO #1 to RO #N in the case the determined starting RO is RO #1; . . . , and the PRACH repetition transmission may be performed in RO #((L−1)×N) to RO #(L×N−1) in the case the determined starting RO is RO #((L−1)×N).

### Option 3:

The UE (or the BS) may determine the candidate starting ROs within the proposed SSB to RO association period based on the above solution 1 or solution 2. The difference is that the candidate starting ROs are determined for each SSB to RO association period. For example, the candidate starting ROs could be determined based on solution 1 (e.g. solution 1-2), but the RO bundles may be determined within a proposed SSB to RO association period. Alternatively, the candidate starting ROs could be determined based on solution 2, but the RO indexing for candidate starting RO determination is within a proposed SSB to RO association period.

For example, L RO bundles determined within each proposed SSB to RO association period. In addition to the first RO of an RO bundle, which is determined as the candidate starting RO for PRACH repetition, the UE may determine another candidate starting RO in one RO bundle in a similar way as in solution 1-2.

FIG. 11 illustrates a proposed SSB to RO association period according to some embodiments of the present disclosure.

The number of PRACH repetition number is 2, and one proposed SSB to RO association period may include 4 ROs associated with each SSB. Taking SSB #0 as an example, there are four ROs associated with SSB #0, which include: RO #0, RO #1, RO #2, and RO #3. The UE may determine at most 3 candidate starting ROs within the proposed SSB to RO association period, which may include: RO #0, RO #1, RO #2. The PRACH repetition transmission may be performed in RO #0 and RO #1 in the case the determined starting RO is RO #0; the PRACH repetition transmission may be performed in RO #1 and RO #2 in the case the determined starting RO is RO #1; and the PRACH repetition transmission may be performed in RO #2 and RO #3 in the case the determined starting RO is RO #2.

In this way, that PRACH repetition is always transmitted within the proposed SSB to RO association period.

Based on the proposed denser candidate starting ROs for PRACH repetition, there may be overlapped ROs involved in more than one PRACH repetitions. For example, referring to FIG. 11, one UE may perform PRACH repetition transmission in RO #1 and RO #2, and another UE may perform PRACH repetition transmission in RO #2 and RO #3. RO #2 is involved in the PRACH repetitions of both UEs.

To differentiate each PRACH repetition in the case of such overlapped ROs and facilitate the BS detecting the PRACH preamble, it is proposed that PRACH preambles are partitioned for the candidate starting ROs.

Specifically, a preamble set may be determined and may be associated with a candidate starting RO. Different candidate starting ROs may be associated with different preamble sets. At UE side, if it decides to start a PRACH repetition from a specific candidate starting RO, it shall select one preamble from the preamble set that is associated with the candidate starting RO, and may start the preamble transmission from the candidate starting RO.

The total number of preamble sets may be determined by the number of PRACH repetition (e.g. N) and the density of the candidate starting ROs. The candidate starting RO density could be either the candidate starting RO periodicity, or the max time gap (in terms of number of ROs) between two neighboring candidate starting ROs for a PRACH repetition. The number of preamble sets could be calculated as: N/N_density, wherein N is the number of PRACH repetition, and N_density is the density of the candidate starting ROs. In some embodiments, the preambles may be equally divided for the determined preamble sets.

FIG. 12 illustrates a method of preamble partitioning for PRACH repetition according to some embodiments of the present disclosure.

In FIG. 12, the PRACH repetition number is 4 and the candidate starting RO periodicity is 1. Correspondingly, the UE may determine 4 preamble sets, which may include preamble set #0, preamble set #1, preamble set #2, and preamble set #3, and each preamble set is associated with a candidate starting RO. For example, candidate starting RO #0 may be associated with preamble set #0; candidate starting RO #1 may be associated with preamble set #1; candidate starting RO #2 may be associated with preamble set #2; and candidate starting RO #3 may be associated with preamble set #3.

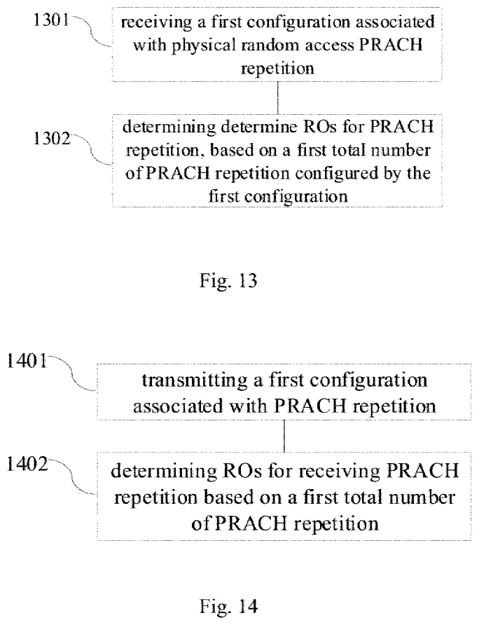

FIG. 13 illustrates a method performed by a UE for wireless communication according to some embodiments of the present disclosure.

In operation 1301, the UE may receive a first configuration associated with PRACH repetition. In operation 1302, the UE may determine ROs for PRACH repetition, based on a first total number of PRACH repetition configured by the first configuration.

FIG. 14 illustrates a method performed by a BS for wireless communication according to some embodiments of the present disclosure.

In operation 1401, the BS may transmit a first configuration associated with PRACH repetition; and in operation 1402, the BS may determine ROs for PRACH repetition, based on a first total number of PRACH repetition.

In some embodiments, the ROs for PRACH repetition are included in at least one RO bundle, and wherein an RO bundle includes a set of ROs associated with an SSB, and the UE or the BS may determine a first RO of an RO bundle as the starting RO for PRACH repetition.

In some embodiments, a first RO bundle associated with the SSB starts from a first RO in a first frame that is associated with the SSB. The first frame may be frame 0.

In some embodiments, the ROs for PRACH repetition are included in one RO bundle, and wherein an RO bundle includes the first total number of ROS associated with an SSB, and the processor is further configured to receive a second configuration which indicates one of the following: a set of indices of candidate starting ROs of the RO bundle; an offset associated with a first RO of the RO bundle; or a total number of candidate starting ROs in the RO bundle.

In some embodiments, the UE or the BS may determine a starting RO of the ROs for PRACH repetition, wherein the starting RO in the RO bundle is one of the following: a first RO of the RO bundle; a candidate starting RO identified by an index of the set of indices; or a candidate starting RO with the offset associated with the first RO of the RO bundle. For example, in FIG. 8, the set of candidate starting RO indices within an RO bundle may include: {RO #0, RO #2}. Therefore, as shown in FIG. 8, there are two candidate starting ROs in RO bundle #0 and RO bundle #1.

In some embodiments, the UE may receive a third configuration from the network, such as the BS, which indicates one of the following: a periodicity of candidate starting ROs associated with an SSB; or the periodicity of candidate starting ROs associated with the SSB and an offset associated with a first RO.

In some embodiments, the UE or the BS may determine a set of candidate starting ROs based on the periodicity or based on the periodicity and the offset, wherein a first candidate starting RO is a first RO associated with the SSB in a first frame. For example, in FIG. 9, the periodicity may be 2, and the candidate starting ROs associated with SSB #0 may include: RO #0, RO #2, RO #4, and RO #6.

In some embodiments, the UE or the BS may determine a period based on the first total number of PRACH repetition, and a second total number of ROS associated with an SSB from a set of SSBs in the period, and wherein the second total number of ROs is equal to or larger than the first total number. In some embodiments, the second total number is an integral multiple of the first total number.

In some embodiments, the period is an SSB to RO association period, or an SSB to RO association pattern period, wherein the SSB to RO association pattern period includes at least one SSB to RO association period.

In some embodiments, the period includes a number of RO bundles, each RO bundle includes a set of ROs associated with the SSB, and the number of ROs in the set is equal to or less than the first total number.

In some embodiments, a candidate starting RO for PRACH repetition is a first RO of an RO bundle.

In some embodiments, each RO associated with the SSB in the period is indexed, and a first RO associated with the SSB in the period is candidate starting RO, and an RO with an index value that is divisible by the first total number is a candidate starting RO. For example, the index may start from 0, then the ROs associated with the same SSB may include: RO #0, RO #N, RO #(2×N), . . . RO #((L−1)×N).

In some embodiments, a candidate starting RO of the ROs for PRACH repetition is associated with a preamble set.

In some embodiments, a total number of preambles in the preamble set is determined by the first total number and a density of candidate starting ROs in a period determined based on the first total number of PRACH repetition.

In some embodiments, the UE or the BS may determine the ROs for PRACH repetition except a starting RO as the ROs associated with a same SSB and following the starting ROs in the time domain, where in the starting RO is associated with the same SSB. For example, in FIG. 9, the starting RO associated with SSB #0 is the RO with the index 2, i.e. RO #2, the other ROs for the PRACH repetition include RO #3, RO #4, and RO #5.

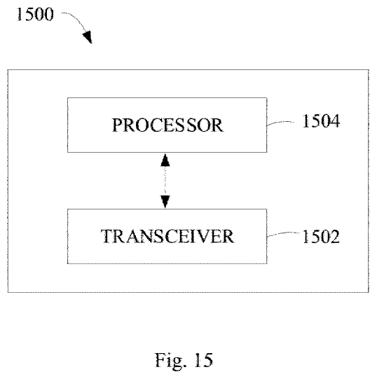

FIG. 15 illustrates a simplified block diagram of an apparatus according to some embodiments of the present disclosure.

As shown in FIG. 15, an example of the apparatus 1500 may include at least one processor 1504 and at least one transceiver 1502 coupled to the processor 1504. The apparatus 1500 may be a UE, a BS, or any other device with similar functions.

Although in this figure, elements such as the at least one transceiver 1502 and processor 1504 are described in the singular, the plural is contemplated unless a limitation to the singular is explicitly stated. In some embodiments of the present disclosure, the transceiver 1502 may be divided into two devices, such as a receiving circuitry and a transmitting circuitry. In some embodiments of the present disclosure, the apparatus 1500 may further include an input device, a memory, and/or other components.

In some embodiments of the present disclosure, the apparatus 1500 may be a UE. The transceiver 1502 and the processor 1504 may interact with each other so as to perform the operations of the UE described in any of FIGS. 1-14. In some embodiments of the present disclosure, the apparatus 1500 may be a BS. The transceiver 1502 and the processor 1504 may interact with each other so as to perform the operations of the BS described in any of FIGS. 1-14.

In some embodiments of the present disclosure, the apparatus 1500 may further include at least one non-transitory computer-readable medium.

For example, in some embodiments of the present disclosure, the non-transitory computer-readable medium may have stored thereon computer-executable instructions to cause the processor 1504 to implement the method with respect to the UE as described above. For example, the computer-executable instructions, when executed, cause the processor 1504 interacting with transceiver 1502 to perform the operations of the UE described in any of FIGS. 1-14.

In some embodiments of the present disclosure, the non-transitory computer-readable medium may have stored thereon computer-executable instructions to cause the processor 1504 to implement the method with respect to the BS as described above. For example, the computer-executable instructions, when executed, cause the processor 1504 interacting with transceiver 1502 to perform the operations of the BS described in any of FIGS. 1-14.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine random access channel occasions (ROs) for physical random access channel (PRACH) repetition within a time period, based at least in part on a first total number of PRACH repetition configured by a first configuration, wherein the ROs within the time period are indexed.

2. The UE of claim 1, wherein the ROs for PRACH repetition are included in at least one RO bundle, and wherein an RO bundle includes a set of ROs associated with a synchronization signal and physical broadcast channel (PBCH) block (SSB), and the at least one processor is further configured to cause the UE to:
determine a first RO of an RO bundle as a starting RO for PRACH repetition.

3. The UE of claim 1, wherein the ROs for PRACH repetition are included in one RO bundle, and wherein the one RO bundle includes a first total number of ROs associated with a synchronization signal and physical broadcast channel (PBCH) block (SSB), and the at least one processor is further configured to cause the UE to receive a second configuration which indicates at least one of:
a set of indices of candidate starting ROs of the one RO bundle;
an offset associated with a first RO of the one RO bundle; or
a total number of candidate starting ROs in the one RO bundle.

4. The UE of claim 3, wherein the at least one processor is further configured to cause the UE to determine a starting RO of the ROs for PRACH repetition, wherein the starting RO in the one RO bundle is at least one of:
a first RO of the one RO bundle;
a candidate starting RO identified by an index of the set of indices; or
a candidate starting RO with the offset associated with the first RO of the one RO bundle.

5. The UE of claim 1, wherein the at least one processor is further configured to cause the UE to:
receive a second configuration, which indicates a periodicity of candidate starting ROs associated with a synchronization signal and physical broadcast channel (PBCH) block (SSB); and
determine a set of candidate starting ROs based at least in part on a periodicity or based at least in part on the periodicity and an offset.

6. (canceled)

7. The UE of claim 1, wherein the at least one processor is further configured to cause the UE to determine a period based at least in part on a total number of PRACH repetitions and a total number of ROs associated with a synchronization signal and physical broadcast channel (PBCH) block (SSB) from a set of SSBs in the period, and wherein the total number of ROs is equal to or larger than the total number of PRACH repetitions.

8. The UE of claim 7, wherein the period is an SSB to RO association period, or an SSB to RO association pattern period, and wherein the SSB to RO association pattern period includes at least one SSB to RO association period.

9. The UE of claim 7, wherein the period includes a number of RO bundles, wherein each RO bundle includes a set of ROs associated with the SSB, and wherein a number of ROs in the set is equal to or less than the first total number of PRACH repetitions.

10. The UE of claim 9, wherein a candidate starting RO for PRACH repetition is a first RO of a RO bundle.

11. The UE of claim 7, wherein each RO associated with the SSB in the period is indexed, and a first RO associated with the SSB in the period is a candidate starting RO, and an RO with an index value that is divisible by the total number of PRACH repetitions is a candidate starting RO.

12. The UE of claim 1, wherein a candidate starting RO of the ROs for PRACH repetition is associated with a preamble set.

13. The UE of claim 12, wherein a total number of preambles in the preamble set is determined by a first total number and a density of candidate starting ROs in a period determined based at least in part on a total number of PRACH repetitions.

14. A base station (BS) for wireless communication, comprising:
at least one memory; and
at least one processor coupled with the at least one memory and configured to cause the BS to:
transmit a first configuration associated with physical random access channel (PRACH) repetition; and
determine random access channel occasions (ROs) for receiving PRACH repetitions based at least in part on a first total number of PRACH repetition.

15. A method performed by a base station (BS), the method comprising:
transmitting a first configuration associated with physical random access channel (PRACH) repetition; and
determining random access channel occasions (ROs) for receiving PRACH repetition based at least in part on a first total number of PRACH repetitions.

16. A method performed by a user equipment (UE), the method comprising:
determining random access channel occasions (ROs) for physical random access channel (PRACH) repetition within a time period, based at least in part on a first total number of PRACH repetition configured by a first configuration, wherein the ROs within the time period are indexed.

17. The method of claim 16, wherein the ROs for PRACH repetition are included in at least one RO bundle, and wherein an RO bundle includes a set of ROs associated with a synchronization signal and physical broadcast channel (PBCH) block (SSB), and further comprising:
determining a first RO of an RO bundle as a starting RO for PRACH repetition.

18. The method of claim 16, wherein the ROs for PRACH repetition are included in one RO bundle, and wherein the one RO bundle includes a first total number of ROs associated with a synchronization signal and physical broadcast channel (PBCH) block (SSB), and further comprising receiving a second configuration which indicates at least one of:
a set of indices of candidate starting ROs of the one RO bundle;
an offset associated with a first RO of the one RO bundle; or
a total number of candidate starting ROs in the one RO bundle.

19. The method of claim 16, further comprising:
receiving a second configuration, which indicates a periodicity of candidate starting ROs associated with a synchronization signal and physical broadcast channel (PBCH) block (SSB); and
determining a set of candidate starting ROs based at least in part on a periodicity or based at least in part on the periodicity and an offset.

20. The method of claim 16, wherein further comprising determining a period based at least in part on a total number of PRACH repetitions and a total number of ROs associated with a synchronization signal and physical broadcast channel (PBCH) block (SSB) from a set of SSBs in the period, and wherein the total number of ROs is equal to or larger than the total number of PRACH repetitions.

21. The method of claim 16, wherein a candidate starting RO of the ROs for PRACH repetition is associated with a preamble set.
